(19) United States
(12) Patent Application Publication
(10) Pub. No.: US 2009/0120260 A1
(43) Pub. Date: May 14, 2009

(54) MANUAL DVD SPLITTER

(75) Inventors: Roger S. Hutchison, Hopkins, MN (US); Hsi-Ling Lee, Taipei (TW)

Correspondence Address: JOEL D. SKINNER, JR.;SKINNER AND ASSOCIATES, 212 COMMERCIAL ST., HUDSON, WI, 54016, US

(73) Assignee: D3, Inc., Eden Prairie, MN (US)

(21) Appl. No.: 12/267,103

(22) Filed: Nov. 7, 2008

Related U.S. Application Data
(60) Provisional application No. 60/986,078, filed on Nov. 7, 2007.

(51) Int. Cl. B26D 1/00; B26D 1/12

(52) U.S. Cl. 83/676; 83/13

(57) ABSTRACT

An apparatus is provided for destroying or disabling an information or data storage device comprising a first layer and a second layer bonded together. A mechanical device or energy form is inserted into the information or data storage device to cause the first and second layers to separate from each other.

### CROSS REFERENCE TO RELATED APPLICATION

This application is based upon co-pending, commonly assigned U.S. Provisional Patent Application Ser. No. 60/986,078, filed Nov. 7, 2007, incorporated herein in its entirety.

### FIELD OF THE INVENTION

The invention herein relates to a device for splitting or separating the information or data layer from the substrate layer on optical discs to include all optical discs such as a digital versatile disc, or DVD, Blu-Ray DVD, HD-DVD, and holographic DVD. More particularly, the invention relates to a device for destroying or disabling the information content layers of DVDs and other optical disc storage media.

### BACKGROUND OF THE INVENTION

One important aspect of our society is the continuing development of technology to store and/or transmit digital information or data. With particular regard to storage technology, it is important that the storage media or apparatuses for the media be capable of either permanently and securely deleting the information from the stored media or disabling or destroying the information layer of the media so that this information or data cannot be used non-authorized persons or in unintended ways. For example, for a compact disc read only memory (CD-ROM), there are known mechanical devices for destroying the information-bearing layer of a CD-ROM. See, for example, U.S. Pat. Nos. 5,954,569, 6,039,637, and 6,334,582. For DVDs, there are other mechanical devices, such as those described in U.S. Pat. Nos. 6,585,177, 6,588,687, and 7,134,940.

A digital versatile disc, or digital video disc, (“DVD”) is a relatively new optical medium, which holds from about seven (4.7 GB) to twenty-eight (50 GB) times the information or data that a CD-ROM can hold, which is 77 times the capacity of a CD-ROM. A new DVD format, the holographic DVD, will soon hold a capacity of 300 GB or 461 times the original CD-ROM media capacity but in nearly the same 12 cm form factor.

Most DVDs are the same physical size as the original CD-ROM media at 12 or 13 cm in circumference. A DVD has the physical atomic material capability to contain at least 10,000 times the original capacity of a CD in the same physical form factor, therefore it is essential that the development of new destruction technologies for this robust media keeps pace with the immense storage capacity. Both corporate and government sensitive data must be protected from unauthorized access on this optical storage medium.

The DVD is a high capacity CD-size disc for data, video, multimedia, games, and audio applications, usually, but not always, in the rare 8 cm and 13 cm or the standard 12 cm diameter format. The depth or thickness of all these optical disc mediums is 1.2 mm. While a CD-ROM disc has the information layer on the surface of a polycarbonate substrate, the information layer of some types of DVDs is contained inside two layers of varying thicknesses of polycarbonate, which have been bonded together. There are also two or more types of erasable or re-writable DVD discs called DVD-RW, which stands for DVD Re-Write, and sometimes DVD erasable as well as DVD RAM which stands for DVD Random Access Memory. Some of these DVD media types have the information containing layer inside two pieces of polycarbonate. Blu-Ray DVD has the data nearly back on the surface just under 0.1 mm thick layer with a substrate layer at 1.1 mm, like CD-ROMs where the data is right on the surface, whereas the standard 4.7 GB DVD and its dual layer counterpart. The 9.5 GB discs as well as the high definition or HD DVDs and the newer holographic DVDs have data inside two pieces of 0.6 mm polycarbonate with multi-data layers combined therein.

There is a need for a simple and efficient way to disable the information-containing layer on a DVD and, after the DVD is disabled, to be able to ascertain that the information can no longer be used.

### OBJECTS OF THE INVENTION

It is an object of the invention to provide a novel means and method for splitting a device for storing and/or transmitting information or data.

It is also an object of the invention to provide a relatively simple and manually operated means and method for destroying information or data storage devices such as DVDs.

It is a further object of this invention is to quickly access the information-containing layer of DVD media which has the information content of the media inside two or more protective polycarbonate or other materials layers for the purposes of rendering the information-containing content layers unusable.

It is a yet further object of the invention to provide an apparatus for manually destroying or disabling an information or data storage device comprising a first layer and a second layer bonded together and a circumferential edge, wherein the apparatus comprises a first circular member, a second circular member, and a circular cutting member rotatably positioned between the first circular member and the second circular member, wherein an annular space is formed by the first circular member, the circular cutting member, and the second circular member, which annular space is sufficient to receive the circumferential edge of the information or data storage device and to cause the first and second layers to separate from each other.

It is a yet further object of the invention to provide an apparatus for manually destroying or disabling an information or data storage device wherein the information or storage device can be rotated.

It is a yet further object of the invention to provide an apparatus for manually destroying or disabling an information or data storage device wherein the information or data storage device is a DVD.

It is a yet further object of the invention to provide an apparatus for manually destroying or disabling an information or data storage device wherein the diameter of each of the first and second circular members is greater than the diameter of the circular cutting member.

It is a yet further object of the invention to provide a method for destroying or disabling an information or data storage device comprising a first layer and a second layer bonded together and a circular edge, which comprises the steps of:
(a) inserting the circular edge of the information or data storage device into an apparatus comprising a first circular member, a second circular member, and a circular cutting member rotatably positioned between the first circular member and the second circular member, wherein an annular space is formed by the first circular member, the circular cutting member, and the second circular member, which annular space is sufficient to receive the circular edge of the information or data storage device, and
(b) causing the apparatus to contact the entire circular edge of the information or data storage device to cause the first and second layers to separate from each other.

It is a yet further object of the invention to provide a method wherein the information or storage device is rotated.

It is a yet further object of the invention to provide a method wherein the information or data storage device is a DVD.

It is a yet further object of the invention to provide a method wherein the first and second layers completely separate from each other.

It is a yet further object of the invention to provide a method wherein in step (b) the first or second layer is reduced to small particle size pieces.

These and other objects of the invention will become more apparent in the discussion below.

### SUMMARY OF THE INVENTION

A representation of a partial cross-section of a typical DVD is set forth in FIG. 1. The primary structural components of a DVD 2 are a first layer 4 and a second layer 6, each of which layer is typically comprised of a polycarbonate with a thickness of about 0.6 mm. Second layer 6 has a reflective layer 8 comprising grooves 10, where information has been laser-etched. An optically transparent bonding layer 12 bonds first layer 4 to second layer 6. Optionally an outer surface 14 of first layer 4 has a label 16.

Grooves on a DVD are often referred to as tracks. Tracks are separated on a DVD by 740 nanometers (0.74 microns) (a nanometer is one billionth of a meter where a micron is one millionth of a meter). This is in contrast to a CD where the tracks are separated by 1600 nanometers (1.6 microns), or roughly 2.16 times larger separation of tracks on a CD as compared to a DVD. The minimum length of the pit or track on a DVD (single-sided) is 400 nanometers (0.4 microns), or roughly 2.08 times smaller than on a CD. If one multiplies 2.16 times 2.075, one appreciates that the capacity increase of a DVD is equal to about 4.5 times. This, along with a less restrictive error correction redundancy code (in a CD-ROM there was a 14 bit-byte instead of the normal 8 bit-byte), leaves the DVD disc containing roughly seven times the information per layer with up to four layers with existing commercial applications. (Thin film technology may alter the capacity of DVDs by adding more layers in the future).

According to the invention here, first DVDs are made unreadable by separating the polycarbonate layers, thereby making the read laser unable to focus on the reflective layer pits, and then there is a secondary physical alteration of the information-bearing layer to alter the pits and tracks in such a manner as to be unreadable with existing technology.

According to the invention, an information or data storage device such as a DVD is split or disabled by causing two layers to separate. In one embodiment of the invention, a sharp or cutting element is inserted or forced between the first and second layers to cause the layers to separate. Optionally the information or data storage device is forced against the cutting element while the information or data storage device is rotated, or the cutting element is rotated on the data storage medium.

In an embodiment of the invention an apparatus for manually destroying or disabling an information or data storage device comprising a first layer and a second layer bonded together and a circumferential edge, the apparatus comprises a first circular member having a top surface, a circumferential surface, a bottom surface, and a diameter, and a second circular member having a top surface, a circumferential surface, a bottom surface, and a diameter. A circular cutting member having a circumferential cutting edge and a diameter is rotatably positioned between the bottom surface of the first circular member and the top surface of the second circular member. An annular space is formed by the first circular member bottom surface, the cutting edge of the circular cutting member, and the second circular member top surface, which annular space is sufficient to receive the circumferential edge of the information or data storage device and to cause the first and second layers to separate from each other.

In another embodiment of the invention, the information or storage device can be rotated.

In a further embodiment of the invention, the information or data storage device is a DVD.

In a yet further embodiment of the invention, the diameter of each of the first and second circular members is greater than the diameter of the circular cutting member.

In an embodiment of a method of the invention for destroying or disabling an information or data storage device comprising a first layer and a second layer bonded together and a circular edge, the method comprises the steps of:

(a) inserting the circular edge of the information or data storage device into an apparatus comprising:

a first circular member having a top surface, a circumferential surface, a bottom surface, and a diameter,

a second circular member having a top surface, a circumferential surface, a bottom surface, and a diameter, and

a circular cutting member having a cutting edge and a diameter and being rotatably positioned between the bottom surface of the first circular member and the top surface of the second circular member,

wherein an annular space is formed by the first circular member bottom surface, the cutting edge of the circular cutting member, and the second circular member top surface, which annular space is sufficient to receive the circular edge of the information or data storage device, and

(b) causing the apparatus to contact the entire circular edge of the information or data storage device to cause the first and second layers to completely separate from each other.

In another embodiment of a method of the invention, the information or storage device is rotated.

In a further embodiment of a method of the invention, the information or data storage device is a DVD.

In a yet further embodiment of a method of the invention, the first and second layers of the information or data storage device completely separate from each other.

In a yet further embodiment of a method of the invention, the information or data storage device is rotated.

In a yet further embodiment of a method of the invention, the information or data storage device is a DVD.

### BRIEF DESCRIPTION OF THE DRAWINGS

FIG. 1 is a representation of a cross-section of a DVD;

FIG. 2 is a perspective view of an embodiment of the invention;

FIGS. 3A to 3C are views of the components of the embodiment of FIG. 2;

FIG. 4 is an oblique view of an embodiment of the invention as in operation;

FIG. 5 is a perspective expanded view of the components of a second embodiment of the invention;

FIG. 6 is a cross-sectional view of a detail of an embodiment of the invention in operation; and

FIG. 7 is a cross-sectional view of a detail of an embodiment of the invention, representing the splitting of a disc.

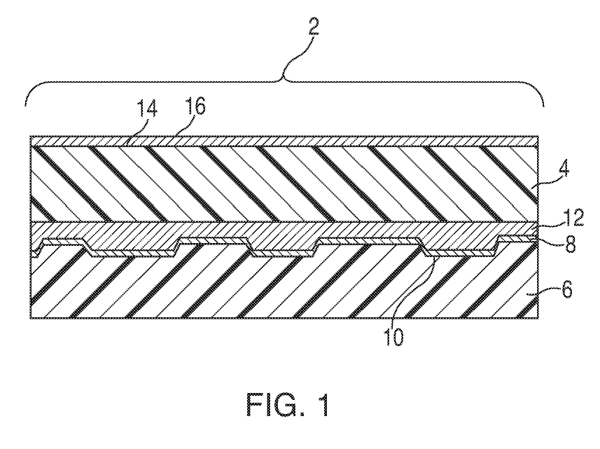

### DETAILED DESCRIPTION OF THE INVENTION

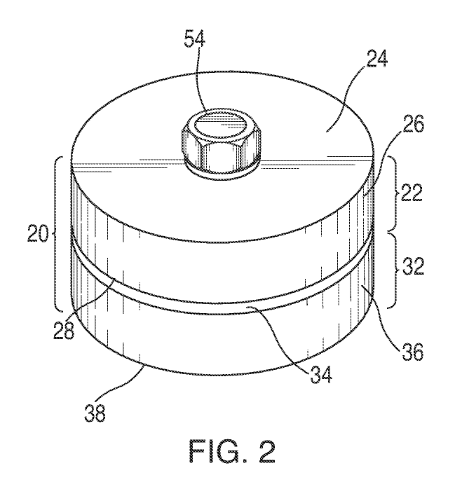

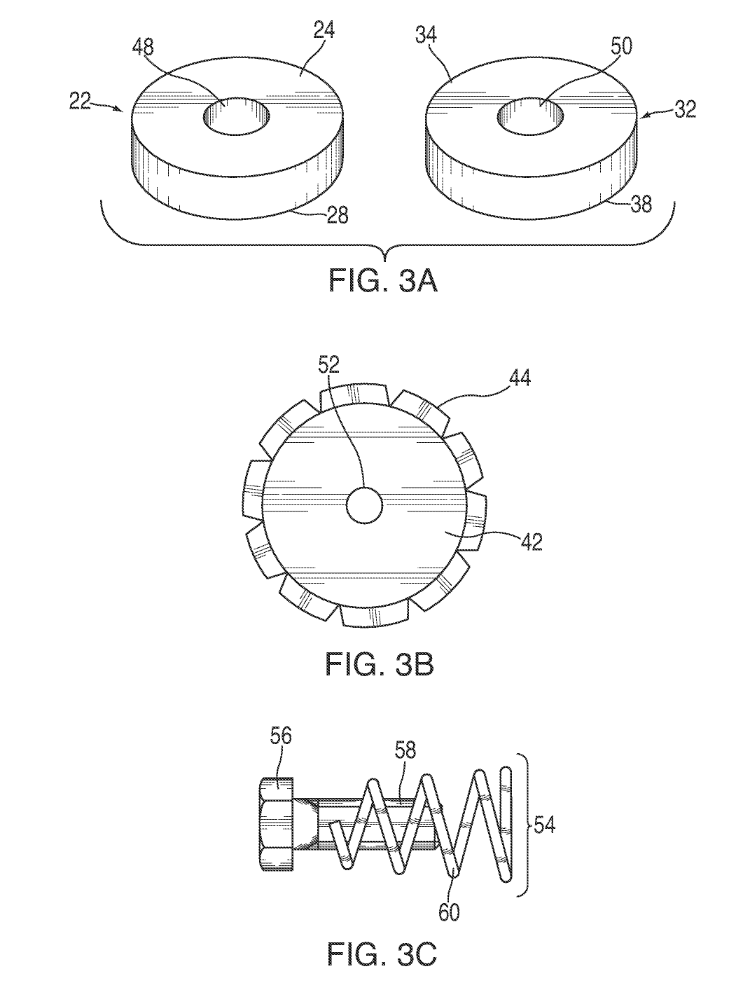

In the embodiment of the invention as shown in FIGS. 2 and 3A to 3C, a disc splitter 20 comprises a first cylindrical member 22 having a top surface 24, a circumferential surface 26, and a bottom surface 28; a second cylindrical member 32 having a top surface 34, a circumferential surface 36, and a bottom surface 38; and a circular cutting member 42 having a cutting edge 44 and being rotatably positioned between bottom surface 28 of first cylindrical member 22 and top surface 34 of the second cylindrical member 32.

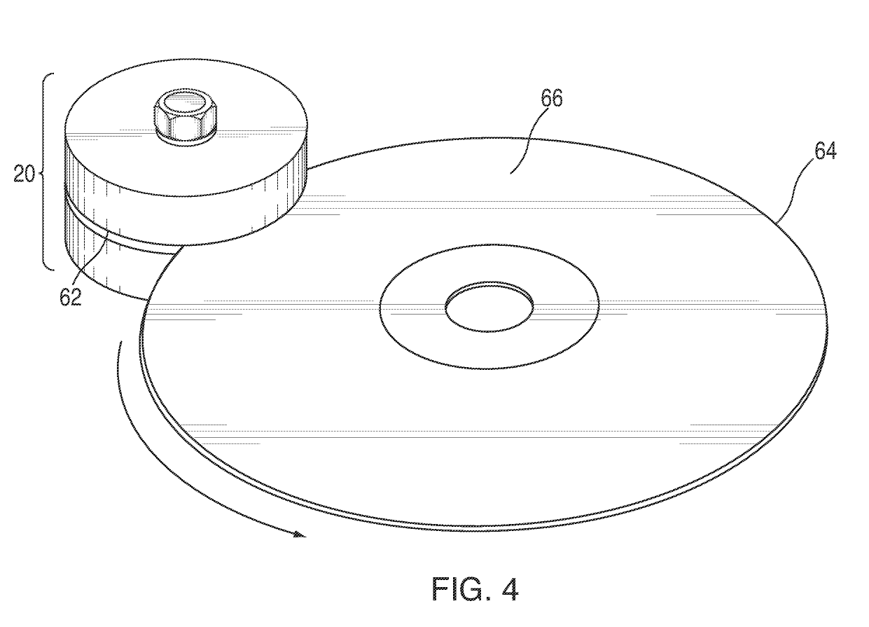

In an embodiment of the invention, first cylindrical member 22 has a circular aperture 48 that extends the from the center of top surface 24 to the center of bottom surface 28; second cylindrical member 32 has a circular aperture 50 that extends from the center of top surface 34 to the center of bottom surface 38; and cutting member 42 has a circular aperture 52. A spring biased bolt 54, having an upper member 56 and an elongated lower member 58 encircled by a spring 60, may be inserted through apertures 48, 50, and 52, each of which are aligned to receive spring biased bolt 54. Spring biased bolt 54 may be adjusted into a locked position, creating, as shown in FIG. 4, an annular space 62 located between the bottom surface 28 of first cylindrical member 22, the cutting edge 44 of circular cutting member 42, and top surface 34 of second cylindrical member 32, which annular space 62 is sufficient to receive a circumferential edge 64 of an information storage device 66. When inserted, circumferential edge 64 of information storage device 66 is biased against cutting edge 44 of circular cutting member 42.

In an embodiment of the invention, first cylindrical member 22 and second cylindrical member 32 have diameters greater than the diameter of cutting member 42.

As illustrated in FIG. 4, when disc splitter 20 is rotated, circumferential edge 64 is forced against cutting member 42 to cause layers of information storage device 66 to separate into two layers. Optionally, information storage device 66 may be rotated to effect separation of the layers.

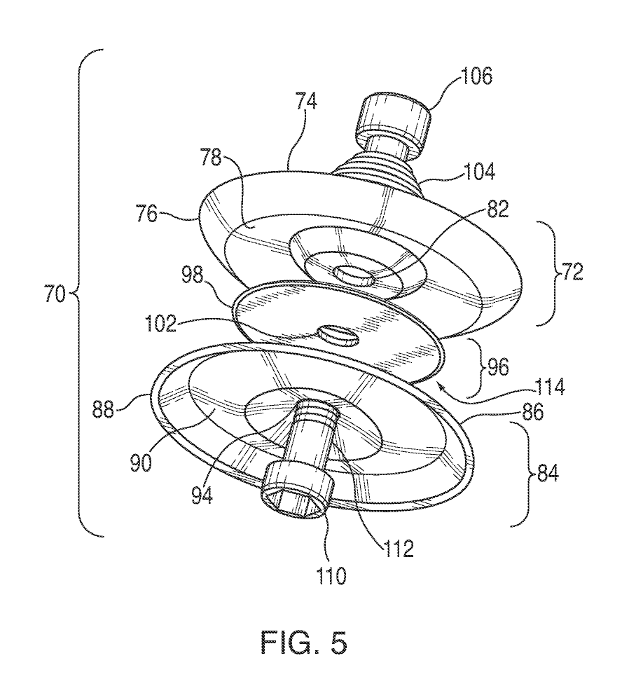

In another embodiment, as illustrated in FIG. 5, a disc splitter 70 comprises a first circular member 72 radially disposed having a top surface 74, a circumferential surface 76, a bottom surface 78, and a circular aperture 82; a second circular member 84 radially disposed and having a top surface 86, a lateral circumferential surface 88, a bottom surface 90, and a circular aperture 94; and a circular cutting member 96 having a cutting edge 98, and a circular aperture 102. Circular cutting member 96 is rotatably positioned between bottom surface 78 of first circular member 72 and top surface 86 of second circular member 84. Disc splitter 70 further comprises a spring 104, a nut 106, and a bolt 108 having an upper member 110 and an elongate lower member 112. Circular apertures 82, 94, 102, and spring 104 may be positioned to receive elongate lower member 112 of bolt 110. When inserted, bolt 110 may be secured by attaching nut 106, creating an annular space 114 located between the bottom surface 78 of first circular member 72, cutting edge 98 of circular cutting member 96, and top surface 86 of second circular member 84, which annular space 114 is sufficient to receive the circumferential edge 64 of the information storage device 66.

Annular space 114 may be adjusted to accommodate discs of different sizes. Annular space 114 may be at a height of about 0.6 mm, but may be adjusted for discs other than DVDs. In Blue Ray high density DVD media, the information bearing layer is under a thin 0.1 mm plastic surface over a 1.1 mm polycarbonate substrate. In HD DVD, the information bearing layer is between two 0.6 mm layers as on a standard 4.7 GB DVD disc. In the holographic DVD discs, the information bearing layer can be within a range of the 1.2 mm polycarbonate surface.

In an embodiment, the device may further comprise a rotary handle attached to a disc or disc holder for moving discs in a rotary manner or a handle attached to device 70 to cause it to turn in a clockwise or counterclockwise direction.

In an embodiment, first circular member 72 and second circular member 84 have diameters greater than the diameter of circular cutting member 96.

In an embodiment, the device may be adapted to accommodate a mechanical motor. The motor may supply energy for operation of the device.

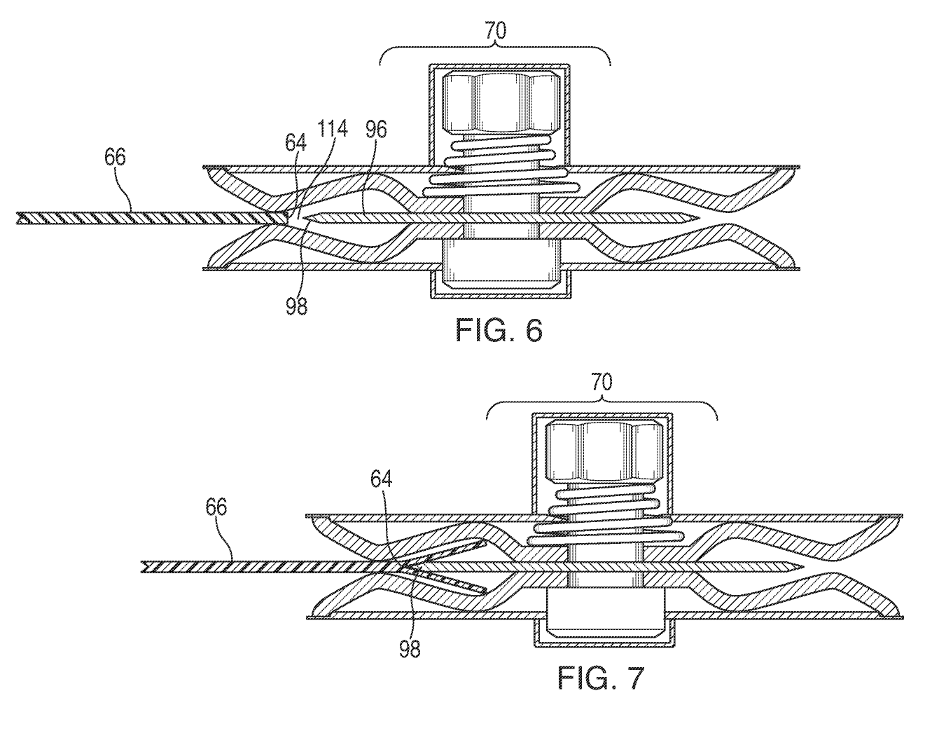

As illustrated in FIGS. 6 and 7, circumferential edge 64 of information storage device 66 is inserted into annular space 114 and is biased against cutting edge 98 of circular cutting member 96. When disc splitter 70 is rotated, circumferential edge 64 is forced against cutting member 96 to cause layers of information storage device 66 to partly or completely separate into two layers. Optionally, information storage device 66 may be rotated to effect separation of the layers.

It is within the scope of the invention that there may be a chemical, electronic, electrical, or mechanical equivalent to cutting member 96 to separate a disc into two layers. For example, there could be a laser member 96 or a heated member 96 that is effective to separate layers.

The technology described and claimed herein is applicable to Type-5 DVDs as well as other information or data storage devices having layers, including, but not limited to, Type DVD-9, Type DVD-10, or Type DVD-18 DVD's. When there are more than two layers, respective adjacent layers can be separated by simultaneous or sequential application of the procedures discussed above.

While the mere act of cutting or splitting a DVD makes the disc unreadable and/or unusable, further secondary processing of the information layer(s) should be conducted after the splitting process to destroy the DVD's or any information contained thereon. These secondary process steps include physical abrasion of the information layer, heat, chemical or laser scoring of the information layer, as well as physical pressure indentation of the information layer(s). Other mechanical or chemical procedures can be used to reduce the split disc members to small particle size pieces, optionally to meet industry or Department of Defense standards.

The preceding specific embodiments are illustrative of the practice of the invention. It is to be understood, however, that other expedients known to those skilled in the art or disclosed herein, may be employed without departing from the spirit of the invention or the scope of the appended claims.

We claim:

1. An apparatus for manually destroying or disabling an information or data storage device comprising a first layer and a second layer bonded together and a circumferential edge, wherein the apparatus comprises:
a first circular member having a top surface, a circumferential surface, a bottom surface, and a diameter,
a second circular member having a top surface, a circumferential surface, a bottom surface, and a diameter, and
a circular cutting member having a circumferential cutting edge and a diameter and being rotatably positioned between the bottom surface of the first circular member and the top surface of the second circular member,
wherein an annular space is formed by the first circular member bottom surface, the cutting edge of the circular cutting member, and the second circular member top surface, which annular space is sufficient to receive the circumferential edge of the information or data storage device and to cause the first and second layers to separate from each other.

2. The apparatus of claim 1, wherein the information or storage device is capable of being rotated.

3. The apparatus of claim 1, wherein the information or data storage device is a DVD.

4. The apparatus of claim 1, wherein the diameter of each of the first and second circular members is greater than the diameter of the circular cutting member.

5. A method for destroying or disabling an information or data storage device comprising a first layer and a second layer bonded together and a circular edge, which comprises the steps of:
(a) inserting the circular edge of the information or data storage device into an apparatus comprising:
a first circular member having a top surface, a circumferential surface, a bottom surface, and a diameter,
a second circular member having a top surface, a circumferential surface, a bottom surface, and a diameter, and
a circular cutting member having a cutting edge and a diameter and being rotatably positioned between the bottom surface of the first circular member and the top surface of the second circular member,
wherein an annular space is formed by the first circular member bottom surface, the cutting edge of the circular cutting member, and the second circular member top surface, which annular space is sufficient to receive the circular edge of the information or data storage device and to cause the first and second layers to separate from each other, and
(b) causing the apparatus to contact the entire circular edge of the information or data storage device to cause the first and second layers to separate from each other.

6. The method of claim 5, wherein the information or storage device is rotated.

7. The method of claim 5, wherein the information or data storage device is a DVD.

8. The method of claim 5, wherein the first and second layers completely separate from each other.

9. The method of claim 5, wherein in step (b) the first or second layer is reduced to small particle size pieces.

10. A device for manually destroying or disabling an information or data storage device comprising a first layer and a second layer bonded together and a circumferential edge, wherein the apparatus comprises:
a first circular member having a top surface, a circumferential surface, a bottom surface, and a diameter,
a second circular member having a top surface, a circumferential surface, a bottom surface, and a diameter, and
a circular cutting member having a circumferential cutting edge and a diameter and being rotatably positioned between the bottom surface of the first circular member and the top surface of the second circular member, and
a handle rotatable in a 360° manner adapted to move a disc in a rotary manner,
wherein an annular space is formed by the first circular member bottom surface, the cutting edge of the circular cutting member, and the second circular member top surface, which annular space is sufficient to receive the circumferential edge of the information or data storage device and to cause the first and second layers to separate from each other.

11. The device of claim 10 further comprising a mechanical motor.

12. The device of claim 10, wherein the annular space may be adjusted to have a height of from about 0.6 to 1.2 mm.
